(19) United States
(12) Patent Application Publication
(10) Pub. No.: US 2008/0294814 A1
(43) Pub. Date: Nov. 27, 2008

(54) Flash Memory System with Management of Housekeeping Operations

(76) Inventor: Sergey Anatolievich Gorobets, Edinburgh (GB)

Correspondence Address: DAVIS WRIGHT TREMAINE LLP - SANDISK CORPORATION, 505 MONTGOMERY STREET, SUITE 800, SAN FRANCISCO, CA, 94111, US

(21) Appl. No.: 11/753,491

(22) Filed: May 24, 2007

(51) Int. Cl. G06F 13/12

(52) U.S. Cl. 710/62

(57) ABSTRACT

A flash re-programmable, non-volatile memory system is operated to disable foreground execution of housekeeping operations, such as wear leveling and data scrub, in the when operation of the host would be excessively slowed as a result. One or more characteristics of patterns of activity of the host are monitored by the memory system in order to determine when housekeeping operations may be performed without significantly degrading the performance of the memory system, particularly during writing of data from the host into the memory.

### CROSS REFERENCE TO RELATED APPLICATION

This application is related to an application being filed concurrently herewith by Sergey Gorobets, entitled “Managing Housekeeping Operations in Flash Memory” which application is incorporated herein in its entirety by this reference.

### GENERAL BACKGROUND

This invention relates generally to the operation of non-volatile flash memory systems, and, more specifically, to techniques of carrying out housekeeping operations, such as wear leveling and data scrub, in such memory systems.

There are many commercially successful non-volatile memory products being used today, particularly in the form of small form factor removable cards or embedded modules, which employ an array of flash EEPROM (Electrically Erasable and Programmable Read Only Memory) cells formed on one or more integrated circuit chips. A memory controller, usually but not necessarily on a separate integrated circuit chip, is included in the memory system to interface with a host to which the system is connected and controls operation of the memory array within the card. Such a controller typically includes a microprocessor, some non-volatile read-only-memory (ROM), a volatile random-access-memory (RAM) and one or more special circuits such as one that calculates an error-correction-code (ECC) from data as they pass through the controller during the programming and reading of data. Other memory cards and embedded modules do not include such a controller but rather the host to which they are connected includes software that provides the controller function. Memory systems in the form of cards include a connector that mates with a receptacle on the outside of the host. Memory systems embedded within hosts, on the other hand, are not intended to be removed.

Some of the commercially available memory cards that include a controller are sold under the following trademarks: CompactFlash (CF), MultiMedia(MMC), Secure Digital (SD), MiniSD, MicroSD, and TransFlash. An example of a memory system that does not include a controller is the SmartMedia card. All of these cards are available from SanDisk Corporation, assignee hereof. Each of these cards has a particular mechanical and electrical interface with host devices to which it is removably connected. Another class of small, hand-held flash memory devices includes flash drives that interface with a host through a standard Universal Serial Bus (USB) connector. SanDisk Corporation provides such devices under its Cruzer trademark. Hosts for memory cards include personal computers, notebook computers, personal digital assistants (PDAs), various data communication devices, digital cameras, cellular telephones, portable audio players, automobile sound systems, and similar types of equipment. A flash drive works with any host having a USB receptacle, such as personal and notebook computers.

Two general memory cell array architectures have found commercial application, NOR and NAND. In a typical NOR array, memory cells are connected between adjacent bit line source and drain diffusions that extend in a column direction with control gates connected to word lines extending along rows of cells. A memory cell includes at least one storage element positioned over at least a portion of the cell channel region between the source and drain. A programmed level of charge on the storage elements thus controls an operating characteristic of the cells, which can then be read by applying appropriate voltages to the addressed memory cells. Examples of such cells, their uses in memory systems and methods of manufacturing them are given in U.S. Pat. Nos. 5,070,032, 5,095,344, 5,313,421, 5,315,541, 5,343,063, 5,661,053 and 6,222,762.

NAND aray utilizes series strings of more than two memory cells, such as 16 or 32, connected along with one or more select transistors between individual bit lines and a reference potential to form columns of cells. Word lines extend across cells within a large number of these columns. An individual cell within a column is read and verified during programming by causing the remaining cells in the string to be turned on hard so that the current flowing through a string is dependent upon the level of charge stored in the addressed cell. Examples of NAND architecture arrays and their operation as part of a memory system are found in U.S. Pat. Nos. 5,570,315, 5,774,397, 6,046,935, 6,373,746, 6,456,528, 6,522,580, 6,771,536 and 6,781,877.

The charge storage elements of current flash EEPROM arrays, as discussed in the foregoing referenced patents, are most commonly electrically conductive floating gates, typically formed from conductively doped polysilicon material. An alternate type of memory cell useful in flash EEPROM systems utilizes a non-conductive dielectric material in place of the conductive floating gate to store charge in a non-volatile manner. A triple layer dielectric formed of silicon oxide, silicon nitride and silicon oxide (ONO) is sandwiched between a conductive control gate and a surface of a semi-conductive substrate above the memory cell channel. The cell is programmed by injecting electrons from the cell channel into the nitride, where they are trapped and stored in a limited region, and erased by injecting hot holes into the nitride. Several specific cell structures and arrays employing dielectric storage elements and are described in U.S. Pat. No. 6,925,007.

As in most all integrated circuit applications, the pressure to shrink the silicon substrate area required to implement some integrated circuit function also exists with flash EEPROM memory cell arrays. It is continually desired to increase the amount of digital data that can be stored in a given area of a silicon substrate, in order to increase the storage capacity of a given size memory card and other types of packages, or to both increase capacity and decrease size. One way to increase the storage density of data is to store more than one bit of data per memory cell and/or per storage unit or element. This is accomplished by dividing a window of a storage element charge level voltage range into more than two states. The use of four such states allows each cell to store two bits of data, eight states stores three bits of data per storage element, and so on. Multiple state flash EEPROM structures using floating gates and their operation are described in U.S. Pat. Nos. 5,043,940 and 5,172,338, and for structures using dielectric floating gates in aforementioned U.S. Pat. No. 6,925,007. Selected portions of a multi-state memory cell array may also be operated in two states (binary) for various reasons, in a manner described in U.S. Pat. Nos. 5,930,167 and 6,456,528.

Memory cells of a typical flash EEPROM array are divided into discrete blocks of cells that are erased together. That is, the block is the erase Unit, a minimum number of cells that are simultaneously erasable. Each block typically stores one or more pages of data, the page being the minimum unit of programming and reading, although more than one page may be programmed or read in parallel in different sub-arrays or planes. Each page typically stores one or more sectors of data, the size of the sector being defined by the host system. An example sector includes 512 bytes of user data, following a standard established with magnetic disk drives, plus some number of bytes of overhead information about the user data and/or the block in which they are stored. Such memories are typically configured with 16, 32 or more pages within each block, and each page stores one or just a few host sectors of data.

In order to increase the degree of parallelism during programming user data into the memory array and read user data from it, the array is typically divided into sub-arrays, commonly referred to as planes, which contain their own data registers and other circuits to allow parallel operation such that sectors of data may be programmed to or read from each of several or all the planes simultaneously. An array on a single integrated circuit may be physically divided into planes, or each plane may be formed from a separate one or more integrated circuit chips. Examples of such a memory implementation are described in U.S. Pat. Nos. 5,798,968 and 5,890,192.

To further efficiently manage the memory, blocks may be linked together to form virtual blocks or metablocks. That is, each metablock is defined to include one block from each plane. Use of the metablock is described in U.S. Pat. No. 6,763,424. The physical address of a metablock is established by translation from a logical block address as a destination for programming and reading data. Similarly, all blocks of a metablock are erased together. The controller in a memory system operated with such large blocks and/or metablocks performs a number of functions including the translation between logical block addresses (LBAs) received from a host, and physical block numbers (PBNs) within the memory cell array. Individual pages within the blocks are typically identified by offsets within the block address. Address translation often involves use of intermediate terms of a logical block number (LBN) and logical page.

It is common to operate large block or metablock systems with some extra blocks maintained in an erased block pool. When one or more pages of data less than the capacity of a block are being updated, it is typical to write the updated pages to an erased block from the pool and then copy data of the unchanged pages from the original block to erase pool block. Variations of this technique are described in aforementioned U.S. Pat. No. 6,763,424. Over time, as a result of host data files being re-witten and updated, many blocks can end up with a relatively few number of its pages containing valid data and remaining pages containing data that is no longer current. In order to be able to efficiently use the data storage capacity of the array, logically related pages of valid data are from time-to-time gathered together from fragments among multiple blocks and consolidated together into a fewer number of blocks. This process is commonly termed “garbage collection.”

Data within a single block or metablock may also be compacted when a significant amount of data in the block becomes obsolete. This involves copying the remaining valid data of the block into a blank erased block and then erasing the original block. The copy block then contains the valid data from the original block plus erased storage capacity that was previously occupied by obsolete data. The valid data is also typically arranged in logical order within the copy block, thereby making reading of the data easier.

Control data for operation of the memory system are typically stored in one or more reserved blocks or metablocks. Such control data include operating parameters such as programming and erase voltages, file directory information and block allocation information. As much of the information as necessary at a given time for the controller to operate the memory system are also stored in RAM and then written back to the flash memory when updated. Frequent updates of the control data results in frequent compaction and/or garbage collection of the reserved blocks. If there are multiple reserved blocks, garbage collection of two or more reserve blocks can be triggered at the same time. In order to avoid such a time consuming operation, voluntary garbage collection of reserved blocks is initiated before necessary and at a times when they can be accommodated by the host. Such pre-emptive data relocation techniques are described in United States patent application publication no. 2005/0144365 A1. Garbage collection may also be performed on user data update block when it becomes nearly full, rather than waiting until it becomes totally full and thereby triggering a garbage collection operation that must be done immediately before data provided by the host call be written into the memory.

In some memory systems, the physical memory cells are also grouped into two or more zones. A zone may be any partitioned subset of the physical memory or memory system into which a specified range of logical block addresses is mapped. For example, a memory system capable of storing 64 Megabytes of data may be partitioned into four zones that store 16 Megabytes of data per zone. The range of logical block addresses is then also divided into four groups, one group being assigned to the physical blocks of each of the four zones. Logical block addresses are constrained, in a typical implementation, such that the data of each are never written outside of a single physical zone into which the logical block addresses are mapped. In a memory cell array divided into planes (sub-arrays), which each have their own addressing, programming and reading circuits, each zone preferably includes blocks from multiple planes, typically the same number of blocks from each of the planes. Zones are primarily used to simplify address management such as logical to physical translation, resulting in smaller translation tables, less RAM memory needed to hold these tables, and faster access times to address the currently active region of memory, but because of their restrictive nature can result in less than optimum wear leveling.

Individual flash EEPROM cells store an amount of charge in a charge storage element or unit that is representative of one or more bits of data. The charge level of a storage element controls the threshold voltage (commonly referenced as V_{T}) of its memory cell, which is used as a basis of reading the storage state of the cell. A threshold voltage window is commonly divided into a number of ranges, one for each of the two or more storage states of the memory cell. These ranges are separated by guardbands that include a nominal sensing level that allows determining the storage states of the individual cells. These storage levels do shift as a result of charge disturbing programming, reading or erasing operations performed in neighboring or other related memory cells, pages or blocks. Error correcting codes (ECCs) are therefore typically calculated by the controller and stored along with the host data being programmed and used during reading to verify the data and perform some level of data correction if necessary.

The responsiveness of flash memory cells typically changes over time as a function of the number of times the cells are erased and re-programmed. This is thought to be the result of small amounts of charge being trapped in a storage element dielectric layer during each erase and/or re-programming operation, which accumulates over time. This generally results in the memory cells becoming less reliable, and may require higher voltages for erasing and programming as the memory cells age. The effective threshold voltage window over which the memory states may be programmed can also decrease as a result of the charge retention. This is described, for example, in U.S. Pat. No. 5,268,870. The result is a limited effective lifetime of the memory cells; that is, memory cell blocks are subjected to only a preset number of erasing and re-programming cycles before they are mapped out of the system. The number of cycles to which a flash memory block is desirably subjected depends upon the particular structure of the memory cells, the amount of the threshold window that is used for the storage states, the extent of the threshold window usually increasing as the number of storage states of each cell is increased. Depending upon these and other factors, the number of lifetime cycles can be as low as 10,000 and as high as 100,000 or even several hundred thousand.

If it is deemed desirable to keep track of the number of cycles experienced by the memory cells of the individual blocks, a count can be kept for each block, or for each of a group of blocks, that is incremented each time the block is erased, as described in aforementioned U.S. Pat. No. 5,268,870. This count may be stored in each block, as there described, or in a separate block along with other overhead information, as described in U.S. Pat. No. 6,426,893. In addition to its use for mapping a block out of the system when it reaches a maximum lifetime cycle count, the count can be earlier used to control erase and programming parameters as the memory cell blocks age. And rather than keeping an exact count of the number of cycles, U.S. Pat. No. 6,345,001 describes a technique of updating a compressed count of the number of cycles when a random or pseudo-random event occurs. The prior arts describe methods of selecting blocks to read data out and blocks to copy the data to preemptively so that wear of blocks is leveled. The selection of blocks can be either based on erase hot counts or simply chosen randomly or deterministically, say by a cyclic pointer. The other periodic housekeeping operation is read scrub scan, which consists of scanning of the data which is not read during normal host command execution, and there is a risk of possible data degradation which is not detected otherwise before it reaches the level of impossible correction by ECC algorithm means or reading with different margins.

### SUMMARY

It is typically desirable to repetitively carry out one or more housekeeping operations not necessary to execute specific commands, according to some timetable in order to maintain the efficient operation of a flash memory system to accurately store and retrieve data over a long life. Examples of such housekeeping operations include wear leveling, data refresh (scrub), garbage collection and data consolidation. Such operations are preferably carried out in the background, namely when it is predicted or known that the host will be idle for a sufficient time. This is known when the host sends an Idle command and forecasted when the host has been inactive for a time such as one millisecond. The risk in performing a housekeeping operation in the background is that it will be either only be partially completed or needs to be aborted entirely if the memory system receives a command from the host before the background operation is completed. Termination of a housekeeping operation in progress takes some time and therefore delays execution of the new host command.

If a sufficient number of housekeeping operations cannot be executed frequently enough in the background to maintain the memory system operating properly, they are then carried out in the foreground, namely when the host may be prepared to send a command but the memory system tells the host that it is busy until a housekeeping operation being performed is completed. The performance of the memory system is therefore adversely impacted when the receipt and/or execution of a host command is delayed in this manner. One effect is to slow down the rate of transfer of data into or out of the memory system.

Example host commands, among many commands, include writing data into the memory, reading data from the memory and erasing blocks of memory cells. The receipt of such a command by the memory system during execution of a housekeeping operation in the background will cut short that operation, with a resulting slight delay to terminate or postpone the operation. Execution of a housekeeping operation in the foreground prevents the host from sending such a command until the operation is completed or at least reaches a certain stage of completion that its completion to be postponed without having to start over again.

In order to minimize these adverse effects, the memory system preferably decides whether to enable execution of a housekeeping operation in either the background or the foreground by monitoring a pattern of operation of the host. If the host is in the process of rapidly transferring a large amount of sequential data with the memory, for example, such as occurs in streaming data writes or reads of audio or video data, an asserted housekeeping operation is disabled or postponed. Similarly, if the host is sending commands or data with very short time delay gaps between separate operations, this shows that the host is operating in a fast mode and therefore indicates the need to postpone or disable any asserted housekeeping operation. If postponed, the housekeeping operation will later be enabled when data are being transferred non-sequentially or in smaller amounts, or when the host delay gaps increase.

In this manner, the memory system is allowed to transfer data at a high rate of speed or otherwise operate in a fast mode when a user expects it to do so. An interruption by a housekeeping operation is avoided in these situations. Since the need for execution of some housekeeping operations is higher with small, non-sequential data transfer operations, there is little penalty in not allowing them to be carried out during large, sequential data transfers.

Housekeeping operations are first enabled to be executed in the background, if allowed, when the host pattern allows since this typically adversely impacts system performance the least. But if enough housekeeping operations cannot be completed fast enough in the background with the restrictions discussed above, then they are carried out in the foreground under similar restrictions. This then provides a balance between competing interests, namely the need for housekeeping operations to be performed and the need for fast operation of the memory system to write and read some data. Another consideration is the amount of power available. In systems or applications where saving power is an issue, the execution of housekeeping operations may, for this reason, be significantly restricted or even not allowed.

Additional aspects, advantages and features of the present invention are included in the following description of exemplary examples thereof, which description should be taken in conjunction with the accompanying drawings.

All patents, patent applications, articles, books, specifications, other publications, documents and things referenced herein are hereby incorporated herein by this reference in their entirety for all purposes. To the extent of any inconsistency or conflict in the definition or use of a term between any of the incorporated publications, documents or things and the text of the present document, the definition or use of the term in the present document shall prevail.

### BRIEF DESCRIPTION OF THE DRAWINGS

FIGS. 1A and 1B are block diagrams of a non-volatile memory and a host system, respectively, that operate together;

FIG. 2 illustrates a first example organization of the memory array of FIG. 1A;

FIG. 3 shows an example host data sector with overhead data as stored in the memory array of FIG. 1A;

FIG. 4 illustrates a second example organization of the memory array of FIG. 1A;

FIG. 5 illustrates a third example organization of the memory array of FIG. 1A;

FIG. 6 shows an extension of the third example organization of the memory array of FIG. 1A;

FIG. 7 is a circuit diagram of a group of memory cells of the array of FIG. 1A in one particular configuration;

FIG. 8 illustrates an example organization and use of the memory array of FIG. 1A;

FIG. 9 is an operational flow chart that illustrates an operation of the previously illustrated memory system that to enable execution of housekeeping operations;

FIG. 10 is an operational flow chart that provides one example of processing within one of the steps of FIG. 9;

FIG. 11 is a timing diagram of a first example operation of the previously illustrated memory system that illustrates the process of FIG. 9; and

FIG. 12 is a timing diagram of a second example operation of the previously illustrated memory system that illustrates the process of FIG. 9.

### DESCRIPTION OF EXEMPLARY EMBODIMENTS

### Memory Architectures and Their Operation

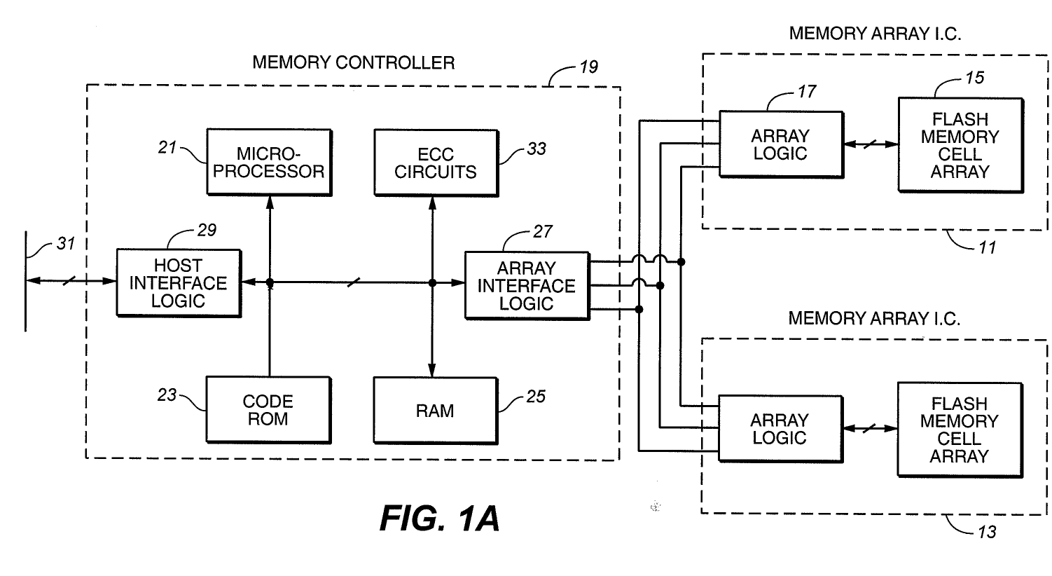

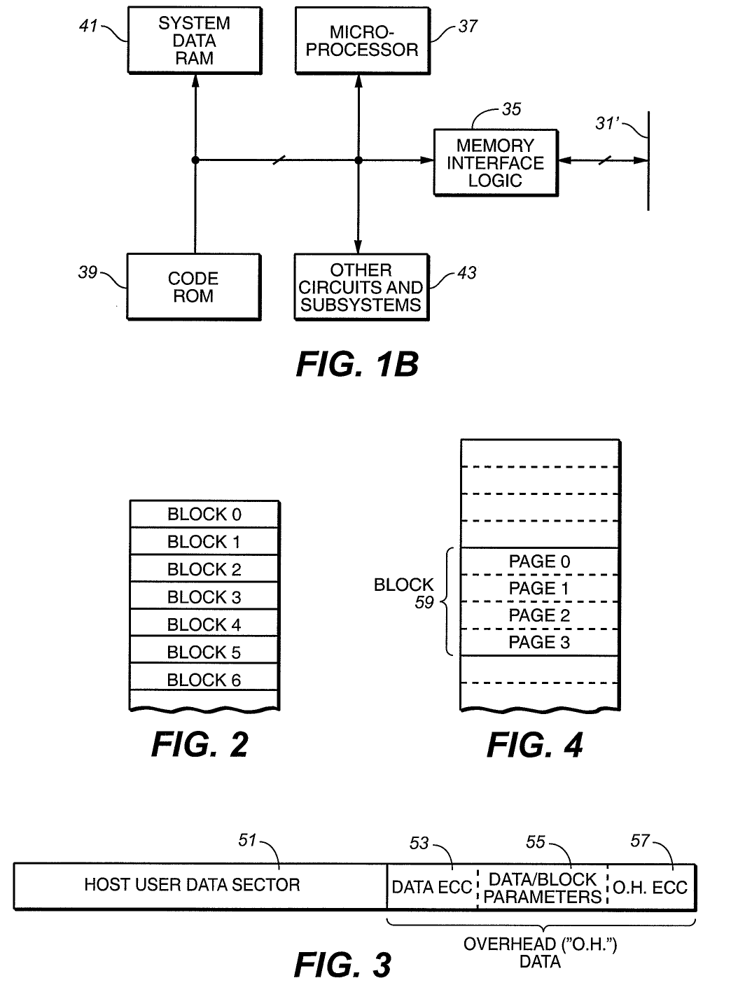

Referring initially to FIG. 1A, a flash memory includes a memory cell array and a controller. In the example shown, two integrated circuit devices (chips) 11 and 13 include an array 15 of memory cells and various logic circuits 17. The logic circuits 17 interface with a controller 19 on a separate chip through data, command and status circuits, and also provide addressing, data transfer and sensing, and other support to the array 13. A number of memory array chips can be from one to many, depending upon the storage capacity provided. The controller and part or the entire array can alternatively be combined onto a single integrated circuit chip but this is currently not an economical alternative. A flash memory device that relies on the host to provide the controller function contains little more than the memory integrated circuit devices 11 and 13.

A typical controller 19 includes a microprocessor 21, a read-only-memory (ROM) 23 primarily to store firmware and a buffer memory (RAM) 25 primarily for the temporary storage of user data either being written to or read from the memory chips 11 and 13. Circuits 27 interface with the memory array chip(s) and circuits 29 interface with a host though connections 31. The integrity of data is in this example determined by calculating an ECC with circuits 33 dedicated to calculating the code. As user data is being transferred from the host to the flash memory array for storage, the circuit calculates an ECC from the data and the code is stored in the memory. When that user data are later read from the memory, they are again passed through the circuit 33 which calculates the ECC by the same algorithm and compares that code with the one calculated and stored with the data. If they compare, the integrity of the data is confirmed. If they differ, depending upon the specific ECC algorithm utilized, those bits in error, up to a number supported by the algorithm, can be identified and corrected.

The connections 31 of the memory of FIG. 1A mate with connections 31′ of a host system, an example of which is given in FIG. 1B. Data transfers between the host and the memory of FIG. 1A are through interface circuits 35. A typical host also includes a microprocessor 37, a ROM 39 for storing firmware code and RAM 41. Other circuits and subsystems 43 often include a high capacity magnetic data storage disk drive, interface circuits for a keyboard, a monitor and the like, depending upon he particular host system. Some examples of such hosts include desktop computers, laptop computers, handheld computers, palmtop computers, personal digital assistants (PDAs), MP3 and other audio players, digital cameras, video cameras, electronic game machines, wireless and wired telephony devices, answering machines, voice recorders, network routers and others.

The memory of FIG. 1A may be implemented as a small enclosed memory card or flash drive containing the controller and all its memory array circuit devices in a form that is removably connectable with the host of FIG. 1B. That is, mating connections 31 and 31′ allow a card to be disconnected and moved to another host, or replaced by connecting another card to the host. Alternatively, the memory array devices 11 and 13 may be enclosed in a separate card that is electrically and mechanically connectable with another card containing the controller and connections 31. As a further alternative, the memory of FIG. 1A may be embedded within the host of FIG. 1B, wherein the connections 31 and 31′ are permanently made. In this case, the memory is usually contained within an enclosure of the host along with other components.

The inventive techniques herein may be implemented in systems having various specific configurations, examples of which are given in FIGS. 2-6. FIG. 2 illustrates a portion of a memory array wherein memory cells are grouped into blocks, the cells in each block being erasable together as part of a single erase operation, usually simultaneously. A block is the minimum unit of erase.

The size of the individual memory cell blocks of FIG. 2 can vary but one commercially practiced form includes a single sector of data in an individual block. The contents of such a data sector are illustrated in FIG. 3. User data 51 are typically 512 bytes. In addition to the user data 51 are overhead data that includes an ECC 53 calculated from the user data, parameters 55 relating to the sector data and/or the block in which the sector is programmed and an ECC 57 calculated from the parameters 55 and any other overhead data that might be included. Alternatively, a single ECC may be calculated from all of the user data 51 and parameters 55.

The parameters 55 may include a quantity related to the number of program/erase cycles experienced by the block, this quantity being updated after each cycle or some number of cycles. When this experience quantity is used in a wear leveling algorithm, logical block addresses are regularly re-mapped to different physical block addresses in order to even out the usage (wear) of all the blocks. Another use of the experience quantity is to change voltages and other parameters of programming, reading and/or erasing as a function of the number of cycles experienced by different blocks.

The parameters 55 may also include an indication of the bit values assigned to each of the storage states of the memory cells, referred to as their “rotation”. This also has a beneficial effect in wear leveling. One or more flags may also be included in the parameters 55 that indicate status or states. Indications of voltage levels to be used for programming and/or erasing the block can also be stored within the parameters 55, these voltages being updated as the number of cycles experienced by the block and other factors change. Other examples of the parameters 55 include an identification of any defective cells within the block, the logical address of the block that is mapped into this physical block and the address of any substitute block in case the primary block is defective. The particular combination of parameters 55 that are used in any memory system will vary in accordance with the design. Also, some or all of the overhead data can be stored in blocks dedicated to such a function, rather than in the block containing the user data or to which the overhead data pertains.

Different from the single data sector block of FIG. 2 is a multi-sector block of FIG. 4. An example block 59, still the minimum unit of erase, contains four pages 0-3, each of which is the minimum unit of programming. One or more host sectors of data are stored in each page, usually along with overhead data including at least the ECC calculated from the sector's data and may be in the form of the data sector of FIG. 3.

Re-writing the data of an entire block usually involves programming the new data into an erased block of an erase block pool, the original block then being erased and placed in the erase pool. When data of less than all the pages of a block are updated, the updated data are typically stored in a page of an erased block from the erased block pool and data in the remaining unchanged pages are copied from the original block into the new block. The original block is then erased. Alternatively, new data can be written to an update block associated with the block whose data are being updated, and the update block is left open as long as possible to receive any further updates to the block. When the update block must be closed, the valid data in it and the original block are copied into a single copy block in a garbage collection operation. These large block management techniques often involve writing the updated data into a page of another block without moving data from the original block or erasing it. This results in multiple pages of data having the same logical address. The most recent page of data is identified by some convenient technique such as the time of programming that is recorded as a field in sector or page overhead data.

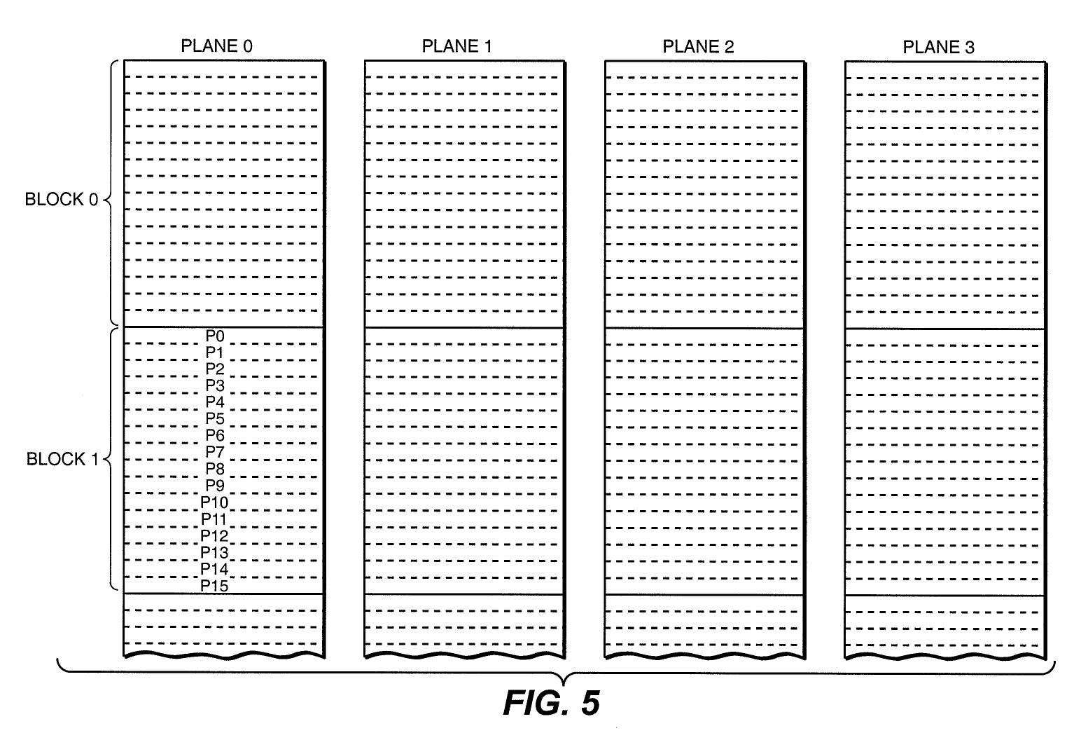

A further multi-sector block arrangement is illustrated in FIG. 5. Here, the total memory cell array is physically divided into two or more planes, four planes 0-3 being illustrated. Each plane is a sub-array of memory cells that has its own data registers, sense amplifiers, addressing decoders and the like in order to be able to operate largely independently of the other planes. All the planes may be provided on a single integrated circuit device or on multiple devices. Each block in the example system of FIG. 5 contains 16 pages P0-P15, each page having a capacity of one, two or more host data sectors and some overhead data. The planes may be formed on a single integrated circuit chip, or on multiple chips. If on multiple chips, two of the planes can be formed on one chip and the other two on another chip, for example. Alternatively, the memory cells on one chip can provide one of the memory planes, four such chips being used together.

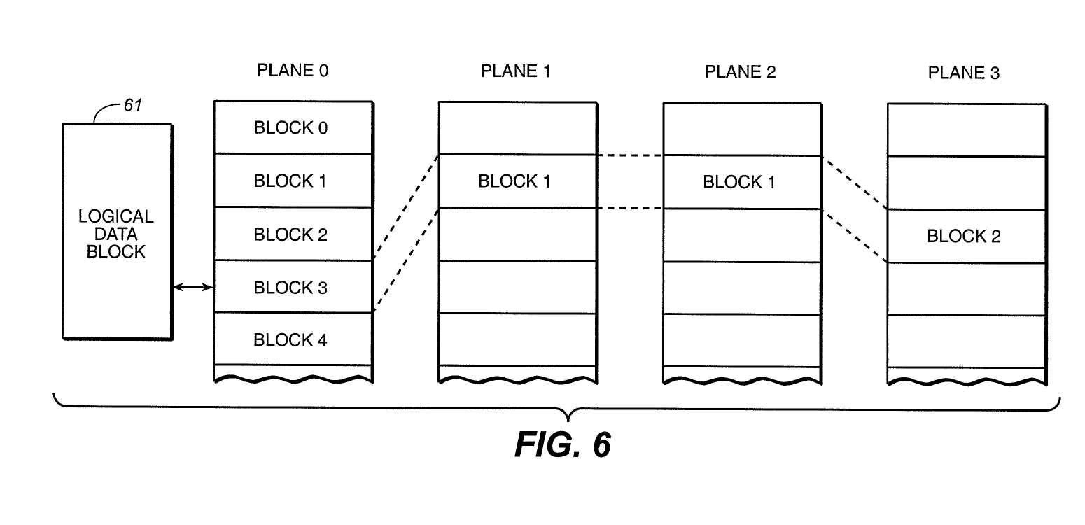

Yet another memory cell arrangement is illustrated in FIG. 6. Each plane contains a large number of blocks of cells. In order to increase the degree of parallelism of operation, blocks within different planes are logically linked to form metablocks. One such metablock is illustrated in FIG. 6 as being formed of block 3 of plane 0, block 1 of plane 1, block 1 of plane 2 and block 2 of plane 3. Each metablock is logically addressable and the memory controller assigns and keeps track of the blocks that form the individual metablocks. The host system preferably interfaces with the memory system in units of data equal to the capacity of the individual metablocks. Such a logical data block 61 of FIG. 6, for example, is identified by a logical block addresses (LBA) that is mapped by the controller into the physical block numbers (PBNs) of the blocks that make up the metablock. All blocks of the metablock are erased together, and pages from each block are preferably programmed and read simultaneously.

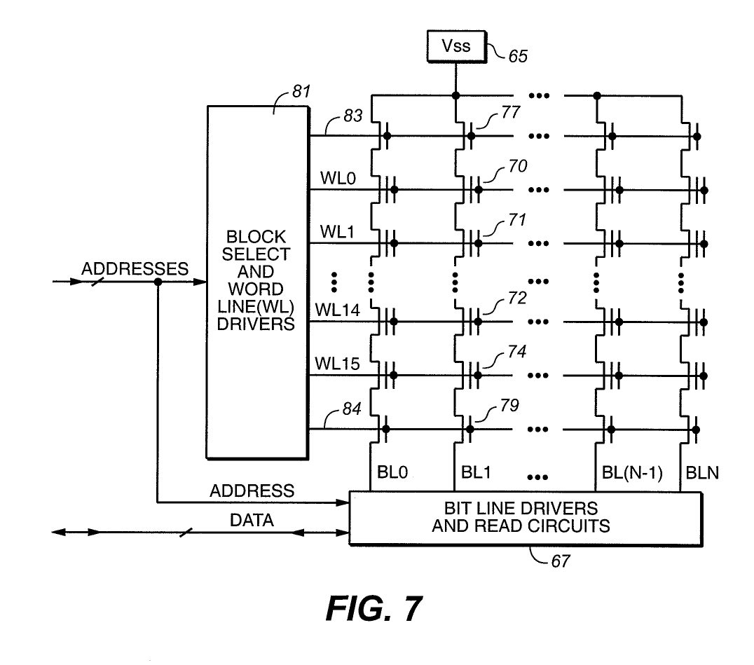

There are many different memory array architectures, configurations and specific cell structures that may be employed to implement the memories described above with respect to FIGS. 2-6. One block of a memory array of the NAND type is shown in FIG. 7. A large number of column oriented strings of series connected memory cells are connected between a common source 65 of a voltage VSS and one of bit lines BL0-BLN that are in turn connected with circuits 67 containing address decoders, drivers, read sense amplifiers and the like. Specifically, one such string contains charge storage transistors 70, 71 . . . 72 and 74 connected in series between select transistors 77 and 79 at opposite ends of the strings. In this example, each string contains 16 storage transistors but other numbers are possible. Word lines WL0-WL15 extend across one storage transistor of each string and are connected to circuits 81 that contain address decoders and voltage source drivers of the word lines. Voltages on lines 83 and 84 control connection of all the strings in the block together to either the voltage source 65 and/or the bit lines BLO-BLN through their select transistors. Data and addresses come from the memory controller.

Each row of charge storage transistors (memory cells) of the block contains one or more pages, data of each page being programmed and read together. An appropriate voltage is applied to the word line (WL) for programming or reading data of the memory cells along that word line. Proper voltages are also applied to their bit lines (BLs) connected with the cells of interest. The circuit of FIG. 7 shows that all the cells along a row are programmed and read together but it is common to program and read every other cell along a row as a unit. In this case, two sets of select transistors are employed (not shown) to operable connect with every other cell at one time, every other cell forming one page. Voltages applied to the remaining word lines are selected to render their respective storage transistors conductive. In the course of programming or reading memory cells in one row, previously stored charge levels on unselected rows can be disturbed because voltages applied to bit lines can affect all the cells in the strings connected to them.

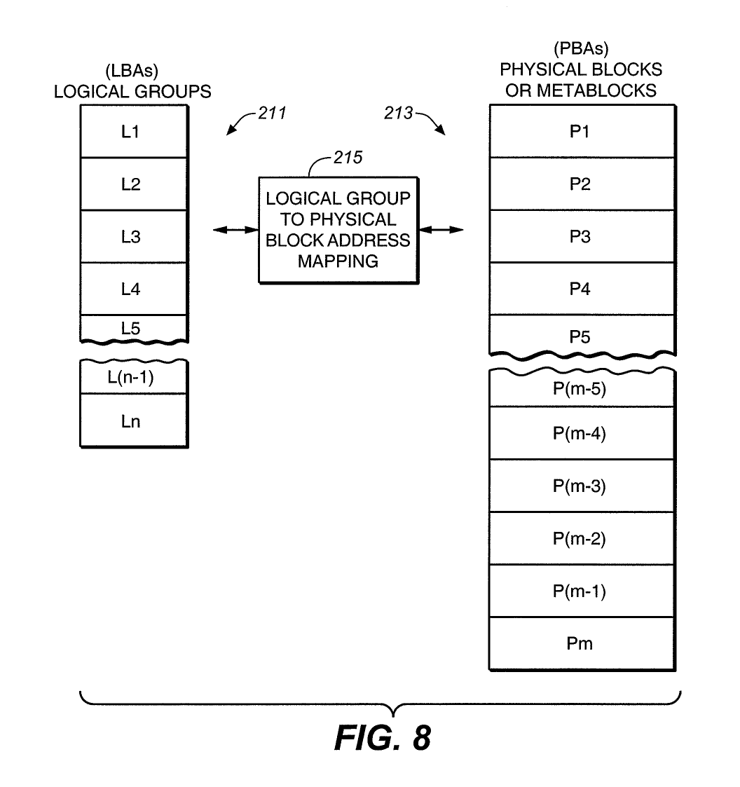

One specific architecture of the type of memory system described above and its operation are generally illustrated by FIG. 8. A memory cell array 213, greatly simplified for ease of explanation, contains blocks or metablocks (PBNs) P1-Pm, depending upon the architecture. Logical addresses of data received by the memory system from the host are grouped together into logical groups or blocks L1-Ln having an individual logical block address (LBA). That is, the entire contiguous logical address space of the memory system is divided into groups of addresses. The amount of data addressed by each of the logical groups L1-Ln is the same as the storage capacity of each of the physical blocks or metablocks. The memory system controller includes a function 215 that maps the logical addresses of each of the groups L1-Ln into a different one of the physical blocks P1-Pm.

More physical blocks of memory are included than there are logical groups in the memory system address space. In the example of FIG. 8, four such extra physical blocks are included. For the purpose of this simplified description provided to illustrate applications of the invention, two of the extra blocks are used as data update blocks during the writing of data and the other two extra blocks male up an erased block pool. Other extra blocks are typically included for various purposes, one being as a redundancy in case a block becomes defective. One or more other blocks are usually used to store control data used by the memory system controller to operate the memory. No specific blocks are usually designated for any particular purpose. Rather, the mapping 215 regularly changes the physical blocks to which data of individual logical groups are mapped, which is among any of the blocks P1-Pm. Those of the physical blocks that serve as the update and erased pool blocks also migrate throughout the physical blocks P1-Pm during operation of the memory system. The identities of those of the physical blocks currently designated as update and erased pool blocks are kept by the controller.

The writing of new data into the memory system represented by FIG. 8 will now be described. Assume that the data of logical group L4 are mapped into physical block P(m-2). Also assume that block P2 is designated as an update block and is fully erased and free to be used. In this case, when the host commands the writing of data to a logical address or multiple contiguous logical addresses within the group L4, that data are written to the update block P2. Data stored in the block P(m-2) that have the same logical addresses as the new data are thereafter rendered obsolete and replaced by the new data stored in the update block L4.

At a later time, these data may be consolidated (garbage collected) from the P(m-2) and P2 blocks into a single physical block. This is accomplished by writing the remaining valid data from the block P(m-2) and the new data from the update block P2 into another block in the erased block pool, such as block P5. The blocks P(m-2) and P2 are then erased in order to serve thereafter as update or erase pool blocks. Alternatively, remaining valid data in the original block P(m-2) may be written into the block P2 along with the new data, if this is possible, and the block P(m-2) is then erased.

In order to minimize the size of the memory array necessary for a given data storage capacity, the number of extra blocks are kept to a minimum. A limited number, two in this example, of update blocks are usually allowed by the memory system controller to exist at one time. Further, the garbage collection that consolidates data from an update block with the remaining valid data from the original physical block is usually postponed as long as possible since other new data could be later written by the host to the physical block to which the update block is associated. The same update block then receives the additional data. Since garbage collection takes time and can adversely affect the performance of the memory system if another operation is delayed as a result, it is not performed every time that it could be performed. Copying data from the two blocks into another block can take a significant amount of time, especially when the data storage capacity of the individual blocks is very large, which is the trend. Therefore, it often occurs when the host commands that data be written, that there is no free or empty update block available to receive it. An existing update block is then garbage collected, in response to the write command and required for its execution, in order to thereafter be able to receive the new data from the host. The limit of how long that garbage collection can be delayed has in this case been reached.

### Housekeeping Operations

Operation of the memory system is in large part a direct result of executing commands it receives from a host system to which it is connected. A write command received from a host, for example, contains certain instructions including an identification of the logical addresses (LBAs of FIG. 8) to which data accompanying the command are to be written. A read command received from a host specifies the logical addresses of data that the memory system is to read and send to the host. There are additionally many other commands that a typical host sends to a typical memory system that are present in the operation of a flash memory system.

But in order to be able to execute the various instructions received from the host, or to be able to execute them efficiently, the memory system performs other functions including housekeeping operations. Some housekeeping operations are performed in direct response to a specific host command in order to be able to execute the command. An example is a garbage collection operation initiated in response to a data write command when there are an insufficient number of erased blocks in an erase pool to store the data to be written in response to the command. Other housekeeping operations are not required for execution of a host command but rather are performed every so often in order to maintain good performance of the memory system without data errors. Examples of this type of housekeeping operations include wear leveling, data refresh (scrub) and pre-emptive garbage collection and data consolidation. A wear leveling operation, when utilized, is typically initiated at regular, random or pseudorandom intervals to level the usage of the blocks of memory cells in order to avoid one or a few blocks reaching their end of life before the majority of blocks do so. This extends the life of the memory with its full data storage capacity.

For a data scrub operation, the memory is typically scanned, a certain number of blocks being scanned at a time on some established schedule, to read and check the quality of the data read from those blocks. If it is discovered that the quality of data in one block is poor, that data is refreshed, typically by rewriting the data of one block into another block from the erase pool. The need for such a data refresh can also be discovered during normal host commanded data read operations, where a number of errors in the read data are noted to be high.

A garbage collection or data consolidation operation is preemptively performed in advance of when it is needed to execute a host write command. For example, if the number of erased blocks in the erase pool falls below a certain number, a garbage collection or data consolidation operation may be performed to add one or more erased blocks to the pool before a write command is received that requires it.

Housekeeping operations not required for the execution of a specific host command are typically carried out in both the background and foreground. Such housekeeping operations occur in the background when the host is detected by the memory system as likely to be idle for a time but a command subsequently received from the host will cause execution of the housekeeping operation to then be aborted and the host command is executed instead. If the host sends an idle command, then a housekeeping operation can be carried out in the background with a reduced chance of being interrupted.

Housekeeping operations may be executed in the foreground by the memory system sending the host a busy status signal. The host responds by not sending any further commands until the busy status signal is removed. Such a foreground operation therefore affects the performance of the memory system by delaying execution of write, read and other commands that the host may be prepared to send. So it is preferable to execute housekeeping operations in the background, when the host is not prepared to send a command, except that it is not known when or if the host will become idle for a sufficient time to do so. Housekeeping operations not required for execution of a specific command received from the host are therefore frequently performed in the foreground in order to make sure that they are executed often enough. At times, there is also a need to perform such a housekeeping operation as soon as possible, such as is the case when the existence of poor quality data is discovered by a routine scrub read scan of the data stored in memory blocks or as a result of reading poor quality data when executing a host read command. Since the poor quality data can be further degraded by continuing to operate the memory system, waiting to perform a refresh of the poor quality data in the background is preferably not an option that is considered.

Several different wear leveling techniques that use individual memory cell block cycle counts are described in U.S. Pat. Nos. 6,230,233, 6,985,992, 6,973,531, 7,035,967, 7,096,313 and 7,120,729. The primary advantage of wear leveling is to prevent some blocks from reaching their maximum cycle count, and thereby having to be mapped out of the system, while other blocks have barely been used. By spreading the number of cycles reasonably evenly over all the blocks of the system, the full capacity of the memory can be maintained for an extended period with good performance characteristics. Wear leveling can also be performed without maintaining memory block cycle counts, as described in United States patent application publication no. 2006/0106972 A1.

In another approach to wear leveling, boundaries between physical zones of blocks are gradually migrated across the memory cell array by incrementing the logical-to-physical block address translations by one or a few blocks at a time. This is described in U.S. Pat. No. 7,120,729.

A principal cause of a few blocks of memory cells being subjected to a much larger number of erase and re-programming cycles than others of the memory system is the host's continual re-writing of data sectors in a relatively few logical block addresses. This occurs in many applications of the memory system where the host continually updates certain logical sectors of housekeeping data stored in the memory, such as file allocation tables (FATS) and the like. Specific uses of the host can also cause a few logical blocks to be re-written much more frequently than others with user data. In response to receiving a command from the host to write data to a specified logical block address, the data are written to one of a few blocks of a pool of erased blocks. That is, instead of re-writing the data in the same physical block where the original data of the same logical block address resides, the logical block address is remapped into a block of the erased block pool. The block containing the original and now invalid data is then erased either immediately or as part of a later garbage collection operation, and then placed into the erased block pool. The result, when data in only a few logical block addresses are being updated much more than other blocks, is that a relatively few physical blocks of the system are cycled with the higher rate. It is of course desirable to provide the capability within the memory system to even out the wear on the physical blocks when encountering such grossly uneven logical block access, for the reasons given above.

When a unit of data read from the memory contains a few errors, these errors can typically be corrected by use of the ECC carried with that data unit. But what this shows is that the levels of charge stored in the unit of data have shifted out of the defined states to which they were initially programmed. These data are therefore desirably scrubbed or refreshed by re-writing the corrected data elsewhere in the memory system. The data are therefore re-written with their charge levels positioned near the middles of the discrete charge level ranges defined for their storage states.

Such poor quality data are detected when the data are read in the course of executing host read commands, and typically as a result of routinely scanning data (scrub scan) stored in a few memory blocks at a time, particularly those data not read by the host for long periods of time relative to other data. The scrub scan can also be performed to detect stored charge levels that have shifted from the middles of their storage states but not sufficient to cause data to be read from them with errors. Such shifting charge levels can be restored back to the centers of their state ranges from time-to-time, before further charge disturbing operations cause them to shift completely out of their defined ranges and thus cause erroneous data to be read.

Scrub processes are further described in U.S. Pat. Nos. 5,532,962, 5,909,449 and 7,012,835, and in U.S. patent applications Ser. Nos. 11/692,840 and 11/692,829, filed Mar. 28, 2007.

Foreground housekeeping operations not required for execution of specific host commands are preferably scheduled in a way that impacts the performance of the memory system the least. Certain aspects of scheduling such operations to be performed during the execution of a host command are described in United States patent application publication nos. 2006/0161724 A1 and 2006/0161728 A1.

### Control of the Enablement of Housekeeping Operations

Since the execution of housekeeping operations in the background or foreground can affect the speed of data transfer and other memory system performance, such executions are disabled during times where they would impact system performance the most. For instance, an interruption in the sequential writing into or reading from the memory of a very large number of units of data of file by executing a housekeeping operation in the foreground may significantly impact performance, particularly when the data is a stream of video or audio data, when high performance is desired or expected. It is not desirable to cause the host during such a process to interrupt the transfer while the memory system performs a housekeeping operation that is not necessary for the memory to execute the current write or read command. In the case of too long a delay, the data buffer can be over-run and data from the stream can be lost. The longer the possible delay, the larger the data buffer that needs to be allocated to provide lossless transfer of a data stream even if the average read or write rate is high enough. Video or audio data streaming should particularly not be interrupted when being done in real time and such an interruption could cause an interruption in a human user's enjoyment of the video or audio content.

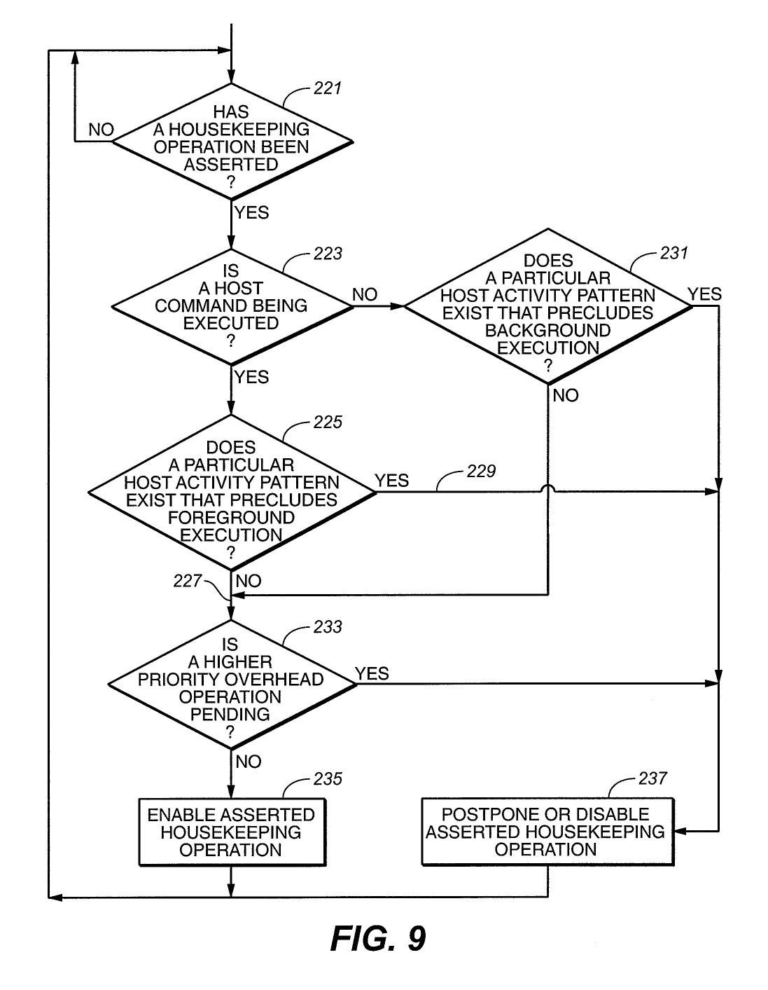

Referring to FIG. 9, an exemplar method of operating the memory system to avoid such interruptions, but yet to also adequately perform such housekeeping operations, is shown. The noting at 221 that a housekeeping operation is to be performed starts the process. Such a housekeeping operation can be, for example, one of wear leveling, data scrub, pre-emptive data garbage collection or consolidation, or more than one of these operations, which are not necessary for the execution of any specific host command. The assertion of a housekeeping operation may be noted as a result of the algorithm for the housekeeping operation being triggered. For example, a wear leveling operation may be triggered after the memory system has performed a pre-set number of block erasures since the last time wear leveling was performed. Similarly, a data scrub read scan may be initiated in a similar manner. A data refresh operation is then initiated, usually on a priority basis, in response to the scrub read scan or normal reading of data discovering that the quality of some data has fallen below an acceptable level. Alternatively, all such housekeeping operations may be listed in a queue when triggered, and the process of FIG. 9 then takes at 221 the highest priority housekeeping operation in the queue. It does not matter to the process of FIG. 9 how the housekeeping operations are triggered or asserted; this is determined by the specific algorithms for the individual housekeeping operations.

At 223, it is determined whether a host command is being executed at this time. The process of FIG. 9 determines whether the housekeeping operation identified at 221 should be performed in the foreground during execution of a host command, or in the background when no host command is being executed by the memory system, or not at all. Whether or when the housekeeping operation is actually executed after being enabled will normally depend on the algorithm for the housekeeping operation, and is not part of the enablement process being described with respect to FIG. 9.

If there is a host command currently being executed, then, at 225, it is determined whether a particular pattern of host activity exists that would cause the asserted housekeeping operation to be disabled or postponed, per 237, rather than to be enabled, per 235. In general, execution of a housekeeping operation not required for execution of the current host command will not be enabled in the foreground if to do so would likely adversely impact execution of the command, such as cause an undesirable slowing of the transfer of a stream of data to or from the host. Whether a foreground execution of a housekeeping operation would have such an effect or not depends on characteristics of the pattern of host activity.

In a preferred embodiment, three different criteria or parameters of the host activity pattern are used to make the decision at 225. A first criterion is the length of data being written into or read from the memory in execution of the command. The header of many host commands includes a field containing the length of data being transferred by the command. This number is compared with a preset threshold. If higher than the threshold, this indicates that the data transfer is a long one and may be a stream of video and/or audio data. In this case, the housekeeping operation is not enabled. If the command does not include the length of the data, then the sectors or other units of data are counted as they are received to see if the total exceeds the preset threshold. There is typically a maximum number of sectors of data that a host may transfer with a single command. The preset threshold may be set to this number or something greater than one-half this number, for example.

A second criterion for use in making the decision at 225 of FIG. 9 is the relationship between the initial LBA specified in the current command and the ending LBA specified in a previous command, typically the immediately preceding command of the same type (data write, data read, etc.). If there is no gap between these two LBAS, then this indicates that the two commands are transferring a single long stream of data or large file. Execution of the housekeeping operation is in that case not enabled. Even when there is some small gap between these two LBAs, this can still indicate the existence of a continuous long stream of data being transferred. Therefore, in 225, it is determined whether the gap between these two LBAs is less that a pre-set number of LBAs. If so, the housekeeping operation is disabled or postponed. If not, the housekeeping operation may be enabled.

The memory system is often operated with two or more update blocks into which data are written from two or more respective files or streams of data. The writing of data into these two or more update blocks is commonly interleaved. In this case, the LBAs are compared between write commands of the same file or data stream, and not among commands to write data of different files to different update blocks.

A third criterion for use at 225 involves the speed of operation of the host. This can be measured in one or more ways. One parameter related to speed is the time delay between when the memory system de-asserts its busy status signal and when the host commences sending another command or unit of data. If the delay is long, this indicates that the host is performing some processing that is slowing its operation. A housekeeping operation may be enabled in this case since its execution will likely not slow the host's operation, or at least will only minimally slow it. But if this delay is short, this indicates that the host is operating fast and that any pending housekeeping operation should be disabled or postponed. A time threshold is therefore set. If the actual time delay is less than the threshold, a housekeeping operation is not enabled.

Another parameter related to speed is the data transfer rate that the host has chosen to use. Not all hosts operate with different data transfer rates. But for those that do, the housekeeping operation is not enabled when the data transfer rate is above a pre-set threshold, since this indicates that the host is operating fast. Any thresholds of host time delays or data transfer speed are set somewhere in between fast and slow extremes that the host is capable of operating under.

If it is decided at 225 that the housekeeping operation may be enabled, it is then considered at 233 whether there is an overhead operation pending that has a higher priority. For example, some overhead operation necessary to allow execution of the current command may need to be performed, such as garbage collection or data consolidation. In this case, the housekeeping operation will be disabled or postponed at least until that overhead operation is completed. Another example is where a wear leveling housekeeping operation has been asserted but a copy of data pursuant to a read scrub scan or other data read becomes necessary. The wear leveling operation

If it is determined at 223 that there is no host command currently being executed, characteristics of the host activity are then reviewed at 231 to determine whether the asserted housekeeping operation can be executed between responding to host commands, in the background. Although the specifics of some of the criteria may be different, they are similar to those of 225 described above, except that the criteria are applied to the most recently executed command since there is no host command currently being executed. If the most recent command, for example, indicates that a continuous stream of data are being transferred, or that the host was operating in a fast mode during its execution, a decision is made at 231 that the housekeeping operation should not be enabled at that time, similar to the effect at 225 for foreground operations. Another criterion, which does not exist at 223, is to use the amount of time that the host has been inactive to make the decision, either solely or in combination with one or more of the other host pattern criteria. For example, if the host has been inactive for one millisecond or more, it may be determined at 231 that the background operation should be enabled unless the host has just before been operating in an extremely fast mode.

In addition to disabling or postponing the housekeeping operation at 237 in the foreground, the asserted operation may be executed in parts to spread out the burden on system performance. For example, during execution of a data write command, all or a part of the operation may be enabled after each cluster or other unit of data is written into the memory system. This can be decided as part of the process of 225. For example, the time delay of the host to respond to the de-assertion by the memory system of its busy status signal can be used to decide how much of the asserted housekeeping operation should be enabled for execution at one time. Such an execution often involves the transfer of multiple pages of data from one memory cell block to another, or an exchange of pages between two blocks, so less than all of the pages may be transferred at successive times until all have been transferred. As the host's delay decreases, the part of the housekeeping operation that is enabled to be performed at one time is decreased until the point is reached that the operation is not enabled at all.

Examples of specific techniques for postponing or disabling the assertion of housekeeping operations at 237 are described with primarily with respect to FIGS. 14A, 14B and 14C of aforementioned United States patent application publication no. 2006/0161724 A1, and FIGS. 13A, 13B and 13C of aforementioned United States patent application publication no 2006/0161728 A1.

In the process illustrated in FIG. 9, the enablement at 235 of a housekeeping operation does not necessarily mean that execution of the operation will commence immediately upon enablement. What is done by the process of FIG. 9 is to define intervals when a housekeeping operation can be performed without unduly impacting on memory system performance. Execution of a housekeeping operation is enabled during these periods but systems identify which operation is to be performed. Further, it is up to an identified housekeeping operation itself as to whether or when it will be executed during any specific time that execution of housekeeping operations are enabled.

The decisions at 225 and 231, whether or not to enable the housekeeping operation, may be made on the basis of any one of the criteria discussed above without consideration of the others For example, the decision may be made by looking only at the length of data for the current command or the immediately prior command, respectively, or only at the gap between its beginning LBA and the last LIBA of a preceding command. However, it is preferable to utilize two or more of the above described criteria to make the decision. In that case, it is preferable to cause the housekeeping operation to be disabled or postponed if any one of the two or more criteria recognizes a pattern in the host's operation which indicates that the housekeeping operation should not be enabled.

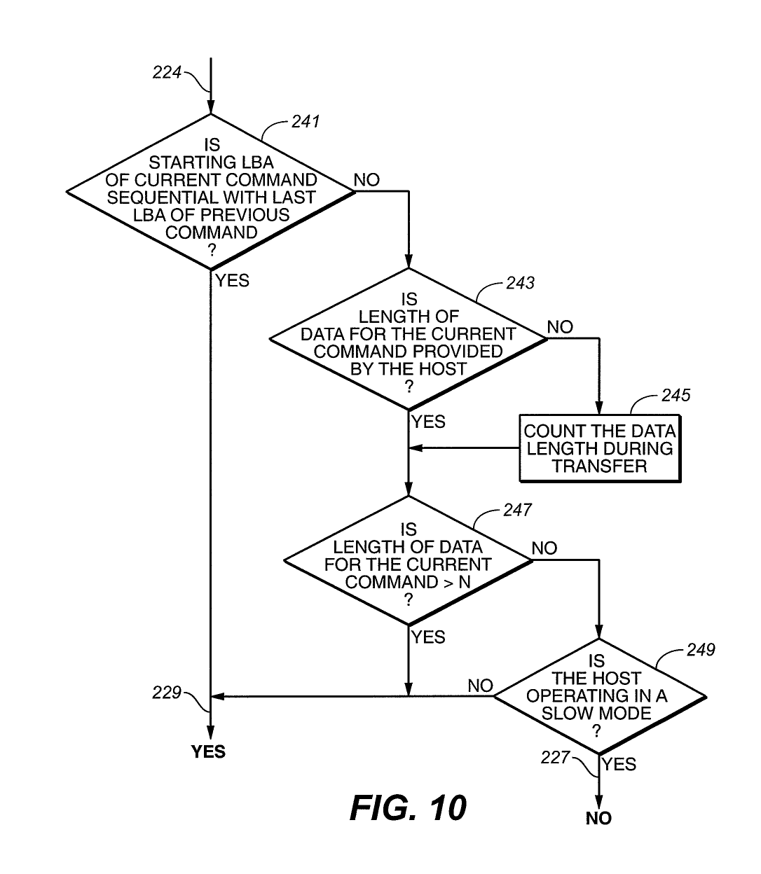

An example of the use of multiple criteria for making the decision of 225 is given in FIG. 10. At 241, the first LBA of the current command is compared with the last LBA of the previous command, in the manner described above. If this comparison shows the data of both commands to be sequential, then the processing proceeds to 237 of FIG. 9, where the asserted housekeeping operation is disabled or postponed.

But if it is not determined at 241 that the data are sequential, the length of data being transferred in response to the current host command is measured and compared with a threshold N. At 243 of FIG. 10, the length of the data is read from the host command, and this length is compared at 247 with the threshold N. If the length exceeds N, this indicates a long or sequential data transfer, so the housekeeping operation is disabled or postponed (237 of FIG. 9). But if the command does not identify the length of data, the units of data being transferred are counted at 245 until reaching the threshold data length N, in which case the housekeeping operation is disabled or postponed.

But if the length of data is determined by 243, 245 and 247 to be N or less, then a third test is performed, as indicated at 249 of FIG. 10. One or more aspects of the host's delays or speed of operation are examined at 249 and compared with one or more respective thresholds, as described above. If the host is operating at a high rate of speed, the process proceeds to 237 (FIG. 9) to disable or postpone the asserted housekeeping operation but if at a low rate of speed, to 235 to enable execution of the operation.

Although the use of three tests is shown in FIG. 10, any one of them may be eliminated and still provide good system management. Further, additional tests can be added. Particularly, at 249, two or more host timing parameters may independently be examined to see if the housekeeping operation needs to be disabled or postponed. If any one of the timing parameters indicates that the host is operating toward a fast end of a possible range, then a housekeeping operation is disabled or postponed. A similar process may be carried out to make the decision at 231 of FIG. 9, except that when a characteristic of the current command is referenced in the above-discussion, that characteristic of the immediately preceding command is used instead.

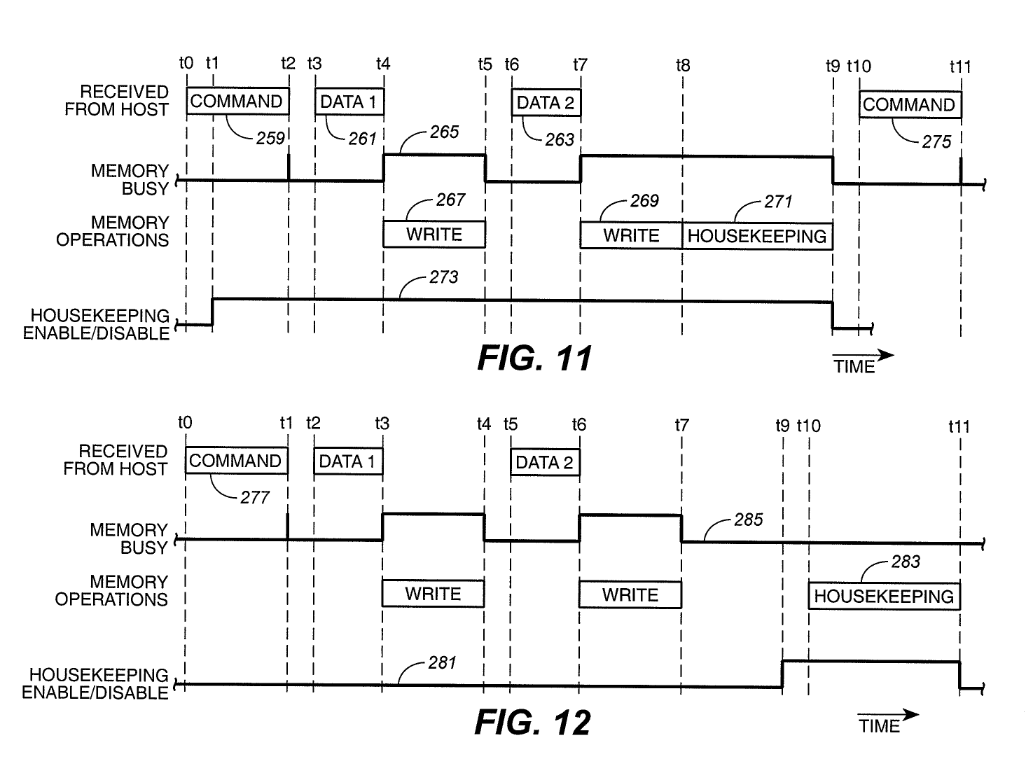

Example timing diagrams of the operation of a host and a memory system to execute host data write commands are shown in FIGS. 11 and 12 to illustrate some of what has been described above. FIG. 11 shows a first command 259 being received by the memory system from a host, followed by two units 261 and 263 of data being received and written into a buffer memory of the host. A memory busy status signal 265 is asserted at times t4 and t7, immediately after each of the data units is received, and is maintained until each of the data units is written into the non-volatile memory during times 267 and 269, respectively. The host does not transmit any data or a command while the busy status signal is asserted. Immediately after the data write 257, at time t5, the busy status signal 265 is de-asserted to enable the host to transmit more data or another command to the memory system. A housekeeping operation is enabled for execution in the foreground during time 271, in this illustrative example, immediately after the data write period 269, so the memory busy status signal 265 is therefore not de-asserted until time t9.

A curve 273 of FIG. 11 indicates when it has been determined to disable or postpone (curve low) enablement of a housekeeping operation (237 of FIG. 9), or to enable (curve high) such an operation (235 of FIG. 9). In this case, the housekeeping operation is shown to be enabled at time t1, while the command is being received from the host by the memory system. This would be the case if the criterion applied to make that choice can be applied that early for this command. If the command contains the length of data that accompanies the command, and only two data units of this example fall below a set threshold, that test (241 of FIG. 10) results in not disabling or postponing the operation. The beginning LBA can also be compared at this early stage with the last LBA of the preceding data write command by this time, in order to apply that criteria (243, 245 and 247 of FIG. 10). But time t1 is too early to measure any delays in response by the host (249 of FIG. 10) when executing the command 259, so in this example of FIG. 11, no host timing criteria are used. The decision at time t1 of FIG. 11 that a housekeeping operation may be enabled has been made from the criteria of 241 and 243/245/247 of FIG. 10.

When the data length is read from the command itself at 243 of FIG. 10, there is a possibility for some hosts that the command may be aborted before that length of data are transferred. This possibility may be taken into account by checking the actual length of data transferred toward the end of the execution of the command. If a housekeeping operation has been disabled or postponed because of a long length of data for a particular command, this added check can cause the decision to be reversed if an early termination of the command is detected. The housekeeping operation may then be enabled instead, before execution of the host command is completed.

Further, in some cases, a host sends a command with an open-ended or very long data length and then later sends a stop command when all the data have been transferred. In this case, the length of data may not be used as a criterion since it is not reliable. Alternatively, the decision whether to enable a housekeeping operation can be postponed until the stop command is received, at which time the actual amount of data transferred with the command is known. If that amount of data are less than the set threshold, a housekeeping operation may be enabled so that it could be executed before the end of the execution of the host command.

It may be noted from the example of FIG. 11 that although execution of the housekeeping operation was enabled at time t1, it was not executed until time t8. This is after the last data received with the command 259 have been written into the non-volatile memory but before a new command 275 has been received. It is generally preferred that all of the data received with the current write command first be written into the non-volatile memory before the housekeeping operation 271 is carried out, so that execution of the host command is completed as soon as possible. But the housekeeping operation could alternatively be executed earlier. Also, a second housekeeping operation could be executed immediately after the write interval 267 if performance requirements of the memory system permit it. It is generally most efficient to execute a housekeeping operation immediately after a memory write but this also is not a requirement. The primary thing that the operating techniques being described herein do is define windows of time during which a housekeeping operation may be executed but it is up to the housekeeping operation itself or other system firmware to manage the specifics of the timing of execution within these defined windows.

When the host timing is used as one or more of the criteria (249 of FIG. 10), intervals of time, illustrated in FIG. 11, are measured and used to decide whether the housekeeping operation is to be disabled or postponed, or whether it is to be enabled. On such interval is t5-t6, the time it takes the host to commence sending the unit 263 of data after the memory busy status signal is non-asserted at time t5. If this interval is short, below some set threshold, this shows that the host is operating at a high rate of speed to transfer data to the memory system. The housekeeping operation will not be executed during such a high speed transfer. But if the interval is longer than the threshold, it is known that the host is not operating particularly fast, so execution of the housekeeping operation need not be postponed or disabled.

Another time interval that may be used in the same way is a time interval t9-t10. This is the time the host takes to send another command after the busy status signal 265 is non-asserted at time t9, after execution of a prior command. When at the short end of a possible range, below a set threshold, this shows that the host is operating in a fast mode, so a housekeeping operation is not executed.

Another timing parameter that may be used is the data transfer rate selected by the host. The higher rate indicates that the housekeeping operation should not be enabled since this would likely slow down the data transfer. One of these timing parameters may be used alone in the processing 249 of FIG. 10, or two or more may be separately analyzed.

FIG. 12 is a timing diagram showing a different example operation. In this case, execution of the housekeeping operation in the foreground is disabled or postponed throughout execution of a first host command 277 because the host pattern satisfied the criteria of 225 of FIG. 9 for not executing the housekeeping operation. But a lengthy delay of host inactivity between time t7, when execution of the command 277 is completed, and a time t9 a preset time thereafter, such as one millisecond, is one of the criteria in 231 of FIG. 9 that can be used to decide that a housekeeping operation may be enabled for execution in the background, even though characteristics of the host activity to execute the command 277 may otherwise decide that it's execution should not be enabled. A housekeeping enable signal then goes active at time t9 and returns to an inactive state t11 after the housekeeping operation 283 has been executed. A busy signal 285 sent by the memory system remains inactive for a time after execution of the command 277 is completed at time t7. The memory system has, in effect, elected to enable execution of the housekeeping operation in the background rather than the foreground during this period of time. This means that a command could be received from the host during execution of the housekeeping operation 283, in which case its execution would have to be terminated so the host command could be executed,

### Conclusion

Although several specific embodiments and possible variations thereof have been described, it will be understood that the present invention is entitled to protection within the full scope of the appended claims.

1. A memory system adapted to be removably connected with a host system, comprising:
an array of re-programmable non-volatile memory cells organized into blocks of memory cells wherein the memory cells of the individual blocks are simultaneously erasable,
a controller including a microprocessor that operates to:
note when a housekeeping operation not required for execution of a command received from a host has been asserted,
determine at least one parameter of activity of the host, and
if the determined at least one parameter meets at least one predefined condition, execution of the housekeeping operation is not enabled, but
if the determined at least one parameter does not meet the predefined condition, the housekeeping operation is enabled for execution.

2. The memory system of claim 1, wherein the controller additionally operates, when execution of the housekeeping operation is enabled, to execute at least one portion of the housekeeping operation while the memory system sends a busy status indication to the host, thereby to execute the housekeeping operation in the foreground.

3. The memory system of claim 1, wherein the controller additionally operates, when execution of the housekeeping operation is enabled, to execute the housekeeping operation while the memory system is not sending a busy status indication to the host, thereby to execute the housekeeping operation in the background.

4. The memory system of claim 1, wherein the housekeeping operation includes rewriting data from one location in the memory system to another location in the memory system.

5. The memory system of claim 3, wherein the housekeeping operation data rewriting is performed as part of either a wear leveling or scrub housekeeping operation.

6. The memory system of claim 1, wherein determining at least one parameter of activity of the host includes monitoring said at least one parameter during execution by the memory system of one of the commands received from the host.

7. The memory system of claim 1, wherein said at least one parameter is a count of a number of logical units of data transferred into or out of the memory as a result of executing a single host command, said at least one predefined condition includes a threshold number of units of data, wherein the one parameter meets the one condition when the count is less than the threshold number and does not meet the one condition when count is greater than the threshold number.

8. The memory system of claim 1, wherein said at least one parameter is a logical address difference between a beginning of data being transferred in response to the command received from the host and an end of data transferred during execution of a previous command received from the host, said at least one predefined condition includes a predefined address difference, wherein the one parameter meets the one condition when the logical address difference is greater than the predefined address difference and does not meet the one condition when the logical address difference is greater than the predefined address difference.

9. The memory system of claim 6, wherein said at least one parameter includes a duration of time of response by the host to the memory system after the memory system indicates to the host that the memory system is not busy, said at least one predefined condition includes a predefined time increment, wherein the one parameter meets the one predefined condition when the time duration is less than the predefined time increment and does not meet the one predefined condition when the time duration is greater than the predefined time increment.

10. The memory system of claim 2, wherein the housekeeping operation includes wear leveling.

11. The memory system of claim 2, wherein the housekeeping operation includes scrub.

12. The memory system of claim 3, wherein the housekeeping operation includes wear leveling.

13. The memory system of claim 3, wherein the housekeeping operation includes scrub.

14. The memory system of claim 1, wherein the current received command is one of a group of commands that individually include data read and data write.

15. The memory system of claim 14, wherein the group of commands additionally includes erase of defined blocks of the memory.
